(19) United States
(12) Patent Application Publication
(10) Pub. No.: US 2025/0054329 A1
(43) Pub. Date: Feb. 13, 2025

(54) SYSTEM AND METHODS FOR MENU CONTENT RECOGNITION USING AI TECHNOLOGIES

(71) Applicants: Harry Tu, Pleasanton, CA (US); Wei Zhu, Beijing (CN)

(72) Inventors: Harry Tu, Pleasanton, CA (US); Wei Zhu, Beijing (CN)

(21) Appl. No.: 18/397,841

(22) Filed: Dec. 27, 2023

Related U.S. Application Data
(60) Provisional application No. 63/532,260, filed on Aug. 11, 2023.

(51) Int. Cl. G06V 30/413; G06F 40/30; G06V 30/244

(52) U.S. Cl. CPC G06V 30/413; G06F 40/30; G06V 30/244

(57) ABSTRACT

The present disclosure relates to systems, software, and computer-implemented methods that automatically recognize content in a document. An example method includes obtaining an image of the document, where the image includes a plurality of text blocks. The method further includes determining textual information of each text block using optical character recognition (OCR) and automatically classifying the plurality of text blocks into a plurality of styles. The method further includes automatically determining a content type of each text block based on a style associated with the text block and textual information of the text block. The method further includes determining semantic relationships between the plurality of text blocks based on one or more of the content type, the textual information, or a location of each text block.

### CROSS-REFERENCE TO RELATED APPLICATIONS

This application claims the benefit of U.S. Provisional Application Ser. No. 63/532,260 filed on Aug. 11, 2023, the entire contents of which are hereby incorporated by reference in its entirety.

### TECHNICAL FIELD

The present disclosure generally relates to pattern recognition and artificial intelligence (AI).

### BACKGROUND

Documents can be converted to digital and editable formats so that data in the documents is easy to access. Manual data extraction from the documents can be inefficient. For example, in restaurant management, paper menus are often made first, and then menu information (such as menu categories, dish names, descriptions, prices, etc.) can be manually entered into a restaurant management system. Menus can be frequently adjusted in restaurant operations. Each time the paper menus are re-designed and printed, the menu information may be entered again into the restaurant management system, which is a time-consuming and labor-intensive task.

### SUMMARY

The present disclosure involves systems, software, and computer-implemented methods that use pattern recognition and AI technology to automatically recognize content in a document. An example method performed by one or more computers includes obtaining an image of a document, where the image includes a plurality of text blocks. The method further includes determining textual information of each text block of the plurality of text blocks using optical character recognition (OCR). The method further includes automatically classifying the plurality of text blocks into a plurality of styles. The method further includes automatically determining a content type of each text block of the plurality of text blocks based on a style associated with the text block and textual information of the text block, where the content type is selected from a plurality of pre-determined content types. The method further includes determining semantic relationships between the plurality of text blocks based on one or more of the content type, the textual information, or a location of each text block of the plurality of text blocks. The method further includes storing the content type and the textual information of each text block and the semantic relationships between the plurality of text blocks into a database.

In some instances, the plurality of text blocks are classified into the plurality of styles based on visual features of each text block. The visual features include one or more of: a width of a stroke line of characters in the text block; a color of the characters in the text block; whether the characters in the text block are uppercase letters; a height of the characters in the text block; or a width of the characters in the text block. In some of those instances, the visual features of each text block further include a sequence of numerical values, and each of the sequence of numerical values is associated with a respective character in the text block and is determined based on an upper limit and a lower limit of a height of the respective character.

In some instances, automatically classifying the plurality of text blocks into the plurality of styles includes automatically classifying the plurality of text blocks using a neural network machine learning model.

In some instances, automatically determining the content type of each text block includes sorting the plurality of styles and arranging the plurality of styles in a hierarchical structure and mapping each style to one of the plurality of pre-determined content types based on a rank of the style in the hierarchical structure. In some of those instances, automatically determining the content type of each text block further includes validating a mapping between the plurality of styles and the plurality of pre-determined content types based on feedback from a user. In some of those instances, automatically determining the content type of each text block further includes determining the content type of each text block further based on semantic analysis of the textual information of the text block.

In some instances, determining the semantic relationships between the plurality of text blocks includes one or more of: determining that a first text block of the plurality of text blocks is associated with a second text block of the plurality of text blocks in response to determining that a content type of the first text block is associated with a content type of the second text block; determining that the first text block is associated with the second text block in response to determining that textual information of the first text block is associated with textual information of the second text block; or determining that the first text block is associated with the second text block in response to determining that the first text block is within a threshold distance from the second text block or is closer to the second text block than other text blocks. In some of those instances, determining the semantic relationships between the plurality of text blocks further includes validating the semantic relationships between the plurality of text blocks based on feedback from a user.

An example system includes one or more computers and one or more storage devices storing instructions that when executed by the one or more computers cause the one or more computers to perform operations. The operations include obtaining an image of a document, where the image includes a plurality of text blocks. The operations further include determining textual information of each text block of the plurality of text blocks using OCR. The operations further include automatically classifying the plurality of text blocks into a plurality of styles. The operations further include automatically determining a content type of each text block of the plurality of text blocks based on a style associated with the text block and textual information of the text block, where the content type is selected from a plurality of pre-determined content types. The operations further include determining semantic relationships between the plurality of text blocks based on one or more of the content type, the textual information, or a location of each text block of the plurality of text blocks. The operations further include storing the content type and the textual information of each text block and the semantic relationships between the plurality of text blocks into a database.

In some instances, the plurality of text blocks are classified into the plurality of styles based on visual features of each text block. The visual features include one or more of: a width of a stroke line of characters in the text block; a color of the characters in the text block; whether the characters in the text block are uppercase letters; a height of the characters in the text block; or a width of the characters in the text block. In some of those instances, the visual features of each text block further include a sequence of numerical values, and each of the sequence of numerical values is associated with a respective character in the text block and is determined based on an upper limit and a lower limit of a height of the respective character.

In some instances, automatically classifying the plurality of text blocks into the plurality of styles includes automatically classifying the plurality of text blocks using a neural network machine learning model.

In some instances, automatically determining the content type of each text block includes sorting the plurality of styles and arranging the plurality of styles in a hierarchical structure and mapping each style to one of the plurality of pre-determined content types based on a rank of the style in the hierarchical structure. In some of those instances, automatically determining the content type of each text block further includes validating a mapping between the plurality of styles and the plurality of pre-determined content types based on feedback from a user. In some of those instances, automatically determining the content type of each text block further includes determining the content type of each text block further based on semantic analysis of the textual information of the text block.

In some instances, determining the semantic relationships between the plurality of text blocks includes one or more of: determining that a first text block of the plurality of text blocks is associated with a second text block of the plurality of text blocks in response to determining that a content type of the first text block is associated with a content type of the second text block; determining that the first text block is associated with the second text block in response to determining that textual information of the first text block is associated with textual information of the second text block; or determining that the first text block is associated with the second text block in response to determining that the first text block is within a threshold distance from the second text block or is closer to the second text block than other text blocks. In some of those instances, determining the semantic relationships between the plurality of text blocks further includes validating the semantic relationships between the plurality of text blocks based on feedback from a user.

An example non-transitory computer-readable storage medium can store instructions that when executed by one or more computers cause the one or more computers to perform operations. The operations include obtaining an image of a document, where the image includes a plurality of text blocks. The operations further include determining textual information of each text block of the plurality of text blocks using OCR. The operations further include automatically classifying the plurality of text blocks into a plurality of styles. The operations further include automatically determining a content type of each text block of the plurality of text blocks based on a style associated with the text block and textual information of the text block, where the content type is selected from a plurality of pre-determined content types. The operations further include determining semantic relationships between the plurality of text blocks based on one or more of the content type, the textual information, or a location of each text block of the plurality of text blocks. The operations further include storing the content type and the textual information of each text block and the semantic relationships between the plurality of text blocks into a database.

In some instances, the plurality of text blocks are classified into the plurality of styles based on visual features of each text block. The visual features include one or more of: a width of a stroke line of characters in the text block; a color of the characters in the text block; whether the characters in the text block are uppercase letters; a height of the characters in the text block; or a width of the characters in the text block.

### DESCRIPTION OF DRAWINGS

FIG. 1 illustrates an example system, in accordance with some aspect of the present disclosure.

FIG. 2 illustrates an image of an example document, in accordance with some aspects of the present disclosure.

FIG. 3 illustrates a flowchart of an example method, in accordance with some aspects of the present disclosure.

FIG. 4 illustrates some example visual features used by a pattern recognition-based style classifier, in accordance with some aspects of the present disclosure.

FIGS. 5A-5B illustrate an example process of a style classifier based on a neural network machine learning model, in accordance with some aspects of the present disclosure.

FIGS. 6A-6B illustrate a flow chart of an example method and an example user interface for a content type determination process, in accordance with some aspects of the present disclosure.

FIGS. 7A-7B illustrate a flow chart of an example method and an example user interface for a semantic relationship determination process, in accordance with some aspects of the present disclosure.

### DETAILED DESCRIPTION

Documents can be converted to digital and editable formats so that data in the documents is easy to access. Manual data extraction from the documents can be inefficient. For example, in restaurant management, paper menus are often made first, and then menu information (such as menu categories, dish names, descriptions, prices, etc.) can be manually entered into a restaurant management system. Menus can be frequently adjusted in restaurant operations. Each time the paper menus are re-designed and printed, the menu information may be entered again into the restaurant management system, which is a time-consuming and labor-intensive task. Therefore, methods for automatic and accurate data entry of information from a document are desired.

Current artificial intelligence (AI) models can recognize printed text accurately but may not understand a role of a recognized text section in the document and/or a semantic relationship between two recognized text sections. General layout analysis can be aimed at documents with a fixed layout structure. However, a document can have various and complex layouts. Thus, existing technologies and products may not accurately extract structured data from the documents, which makes the automatic data entry process of the documents difficult.

The present disclosure provides AI-based methods and systems for automatic recognition and entry of structured data in a document. In one example, a computer implemented method includes obtaining an image of a document. The image includes text blocks, where textual information of each text block can be determined using optical character recognition (OCR). The text blocks can be automatically classified into different styles. A content type of each text block and semantic relationships between the text blocks also can be automatically determined. In some implementations, the method further includes classifying the text blocks using pattern recognition and/or machine learning (ML) techniques. In some implementations, to improve accuracy of the recognition, classification and recognition results can be validated and adjusted by a user before being stored in a database.

The proposed techniques described in this disclosure can be implemented to realize one or more of the following advantages. First, the proposed techniques use automatic data process and analysis, thereby saving time and avoiding unnecessary effort caused by a time-consuming and labor-intensive manual entry process. Second, the proposed techniques can obtain more reliable and more accurate documents recognition results. Manual entry of documents often results in entry errors, which will cause economic loss. For example, an error in price related data in a point-of-sale (POS) system of a merchant may cause direct economic loss to the merchant. It also can require costly work to re-enter the data or to fix the error in the POS system. Third, compared to manual entry of documents and traditional OCR technology, the proposed techniques can extract structured data from the documents, and thus, can be used to improve productivity. For example, traditional OCR technology can recognize text from a menu of a restaurant, but may not recognize structured data from the menu including semantics from the text and content information such as dish categories, item names, prices, and descriptions. The production efficiency of various industries such as restaurants and catering business can be enhanced using the techniques described in the present disclosure.

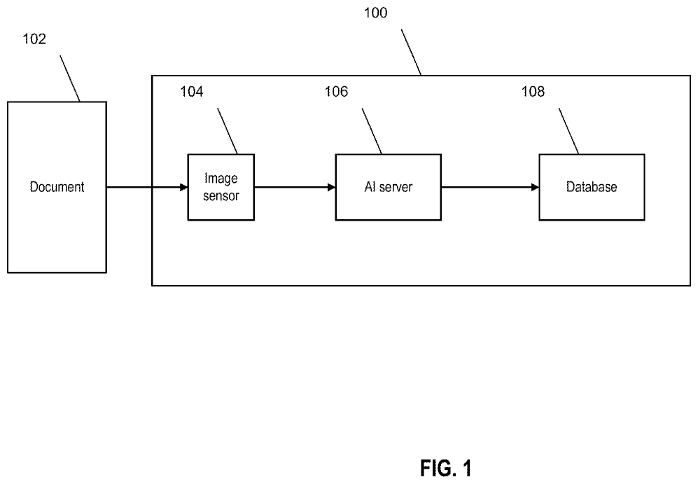

FIG. 1 illustrates an example system 100 for performing the subject matter described herein, in accordance with some aspect of the present disclosure. System 100 can include an image sensor 104, an AI server 106, and a database 108. Image sensor 104 can be a camera, a scanner, or any suitable device capable of taking pictures. In some implementations, image sensor 104 can be a smartphone or a tablet (e.g., an iPhone or iPad) with a document scan function (e.g., an iOS file scan function). A document 102 can be a regular document printed on a paper. A user can use image sensor 104 to generate a digital image of document 102 (e.g., by taking a photo of document 102 or scanning document 102). Then, image sensor 104 can transmit the generated image (e.g., a digital file in an image format or a Portable Document Format (PDF)) to AI server 106.

Image sensor 104 can be optional if document 102 in a suitable digital format (e.g., a digital image, a PDF file, or a webpage) is already available. In this case, the user can provide the digital file of document 102 to AI server 106. The user may upload the digital file from a local computer, provide a cloud storage location of the file, or provide a uniform resource locator (URL) of a webpage (if document 102 is the webpage). In some implementations, AI server 106 is configured to process a screenshot of the webpage.

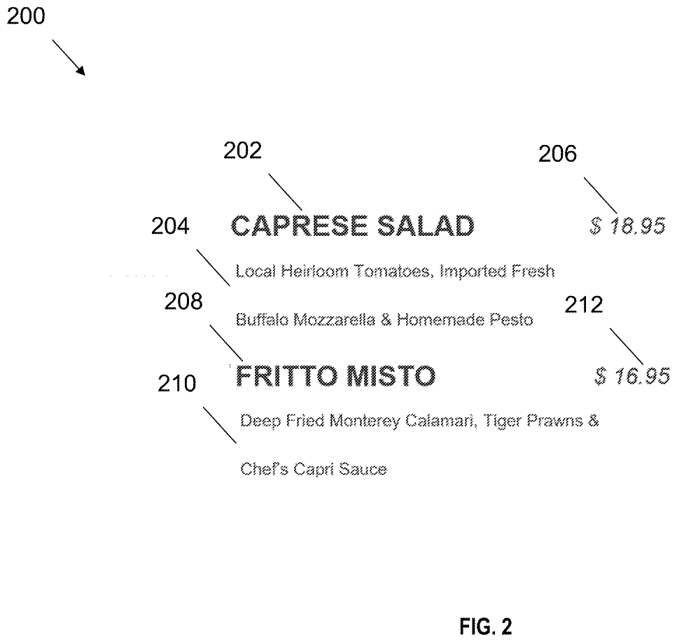

FIG. 2 illustrates an image 200 of an example document 102, in accordance with some aspects of the present disclosure. In this example, document 102 is one page of a restaurant menu, which includes a list of food offered to customers. As shown in FIG. 2, image 200 includes text blocks 202-212 associated with two dishes “Caprese salad” and “Fritto misto.” Each text block is a part of image 200 that includes a string of characters. In some implementations, text blocks and textural information of each text block can be determined by applying optical character recognition (OCR) text recognition algorithms to image 200. Textual information of text block 202 represents a name of the first dish “Caprese salad.” Textual information of text block 204 provides a description of the first dish. Textual information of text block 206 represents a price of the first dish. Text blocks 208, 210, and 212 include textual information representing a name, a description, and a price of the second dish “Fritto misto,” respectively. In some implementations, image 200 further include other information such as food categories (e.g., “appetizer,” “entree,” “dessert,” and “wine list”), restaurant names, and restaurant introductions.

Returning to FIG. 1, AI server 106 is configured to process and analyse the image of document 102 (e.g., image 200 of FIG. 2) and recognize and extract structured data from the image. The structured data include not only textural information in the image (e.g., textural information of each text blocks 202-212 of FIG. 2) but also a content type of each text block (e.g., text blocks 202 and 208 representing dish names, and text blocks 206 and 212 representing dish prices) and semantic relationships between text blocks (e.g., text blocks 202, 204, and 206 being associated with the first dish, and text blocks 202, 204, and 206 being associated with the second dish). AI server 106 can run various models and algorithms for data recognition and can present recognized results on a user interface in a navigational style for the user to confirm. If the user believes that certain information has been recognized incorrectly, the user can delete the incorrect part via the user interface. AI server 106 can re-recognize the deleted information, and present new recognition result again through the user interface for confirmation. The confirmation or validation process may take several rounds before accurate recognition of contents on document 102 is determined.

Recognition results generated by AI server 106 can be stored in a database 108 in a suitable database format. Database 108 can be located in a dedicated server for document storage. In some implementations, database 108 can be integrated into a POS system.

In some implementations, an advanced style classifier is developed to identify and classify different types of contents in document 102. The style classifier can combine pattern recognition and neural network technologies. In some implementations, text content on document 102, the classification of different text blocks in document 102, or the semantic relationships between the text blocks can be read and recognized based on OCR text recognition technology, a style classifier, and a language model. In some implementations, suggestions for the recognition of content types (e.g., dish names, dish descriptions, and dish prices as shown in FIG. 2) can be provided based on a series of AI recognitions methods. In some implementations, a user confirmation program that allows a user to adjust the recognition results is also implemented.

While in this disclosure some examples are described in the context of a restaurant menu, it is understood that techniques described in this disclosure are applicable to any suitable types of documents including, but not limited to, certificates, identification cards, purchase orders, receipts, tax forms, etc.

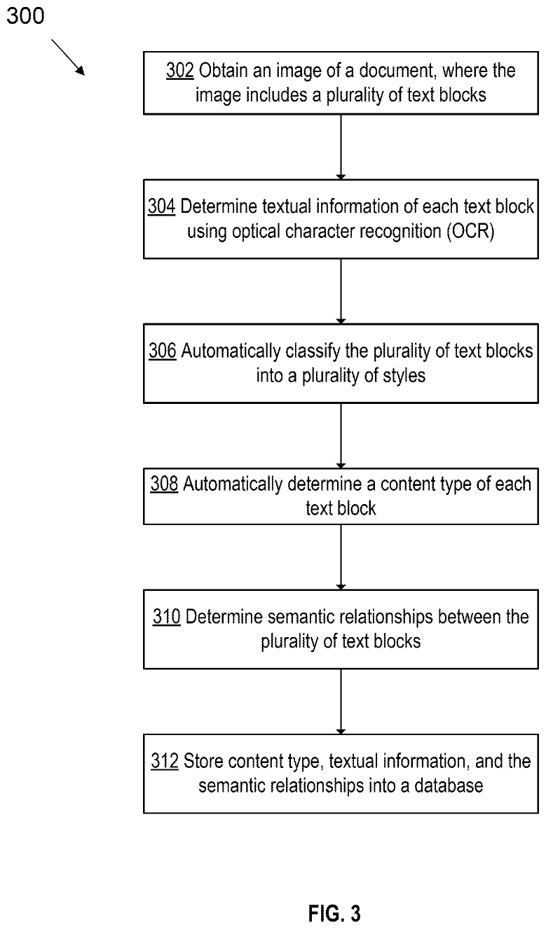

FIG. 3 illustrates a flowchart of an example method 300, in accordance with some aspects of the present disclosure. Method 300 can be performed by any suitable system (such as system 100 of FIG. 1).

At 302, the system can obtain an image (e.g., image 200 of FIG. 2) of a document (e.g., document 102 of FIG. 1). The image can include a plurality of text blocks (e.g., text blocks 202-212 of FIG. 2). In some implementations, an image sensor (e.g., image sensor 104 of FIG. 1) of the system can be used to take a photo of the document. Then, the system can use a correction model to correct or adjust the image to make the image smoother or more legible for the following operations. For example, an iOS file scan function can be used to capture and enhance the photo. It should be understood that the iOS file scan function is for illustration purposes, and that any suitable image correction or enhancement models and functions can be applied at 302.

At 304, the system can determine textual information of each text block of the plurality of text blocks using OCR. That is, the system may use an AI OCR model to recognize text content on the image. In some implementations, the AI OCR model returns the plurality of text blocks of the image, lines of text (e.g., textual information of each text block). The AI OCR model can also provide a position of each text block and the confidence level of the recognition result for each text block.

At 306, the system can classify the plurality of text blocks into a plurality of styles. The classification can be automatically performed by the system without user input or user interaction. Styles of text on a document may carry rich semantic information. The reason for designing a style classifier is that on a document, a certain style often represents a fixed type of content. For example, larger fonts represent dish categories, italic fonts represent prices, and smaller fonts can represent dish descriptions. As shown in FIG. 2, text blocks 202-212 have different styles. Text blocks 202 and 208 (dish names) use the same bold and all capital font of a larger size (which can be referred to as style 1 or font 1), text blocks 206 and 212 (dish prices) use the same italic font of a medium size (which can be referred to as style 2 or font 2), and text blocks 204 and 210 (dish descriptions) use the same normal font of a smaller size (which can be referred to as style 3 or font 3). It can be inferred from these different styles that there may be different types of content in image 200, and that some text blocks are of the same content type, and some others are not. As such, the recognition result from 304 (such as text blocks) can be classified into different styles using an AI style classifier model. The style classifier may automatically classify and number the styles of all recognized text blocks on the document. In some implementations, each text block may contain only one style type.

A style of a recognized text block may include one or more distinction features such as fonts, indentions, bullets, font color, background color, etc. In some implementations, the style may include a combination of the above-mentioned distinction features. In some implementations, the style classifier can be a font classifier that focuses on font-related distinction features. A font classifier may be used to classify font types included in the document. Fonts that belong to the same category may represent the same type of content. Based on font classification, semantic classification for each font type can then be inferred.

In some implementations, the font classifier may identify a font type that a text block is using. For example, dish names of a menu may use Arial, and dish prices may use Calibri. In some other implementations, the font classifier may detect that two text blocks use different font types but may not identify a specific font type each text block uses. For example, the font classifier does not recognize whether a font is Arial or not. Rather, the font classifier classifies fonts included in a document (e.g., a menu) into distinct categories and assign each of them with a number. For example, a menu may have 6 different fonts, with font 2 being used for dish names and font 5 being used for dish prices. In some implementations, the numbers can be automatically assigned by the font classifier.

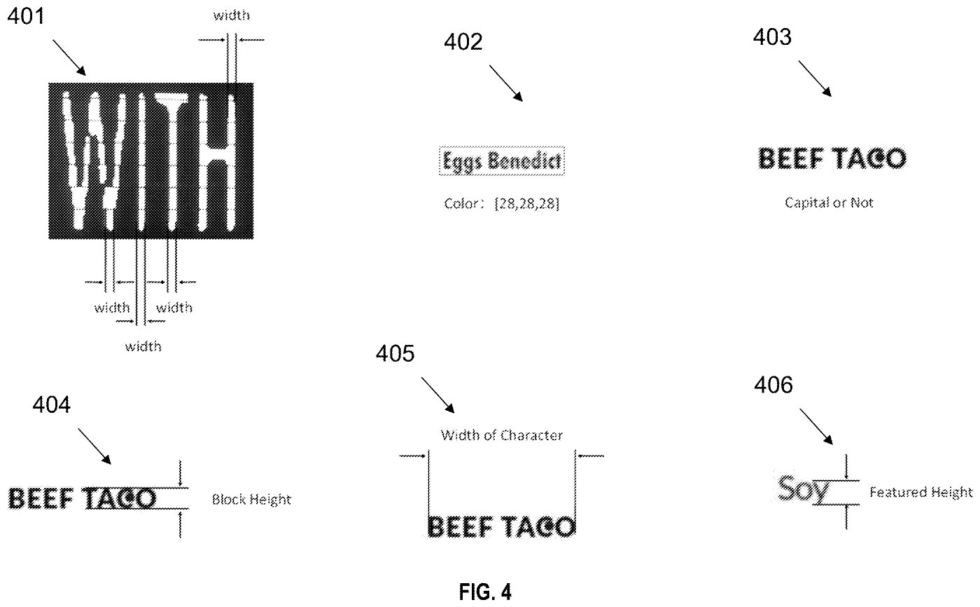

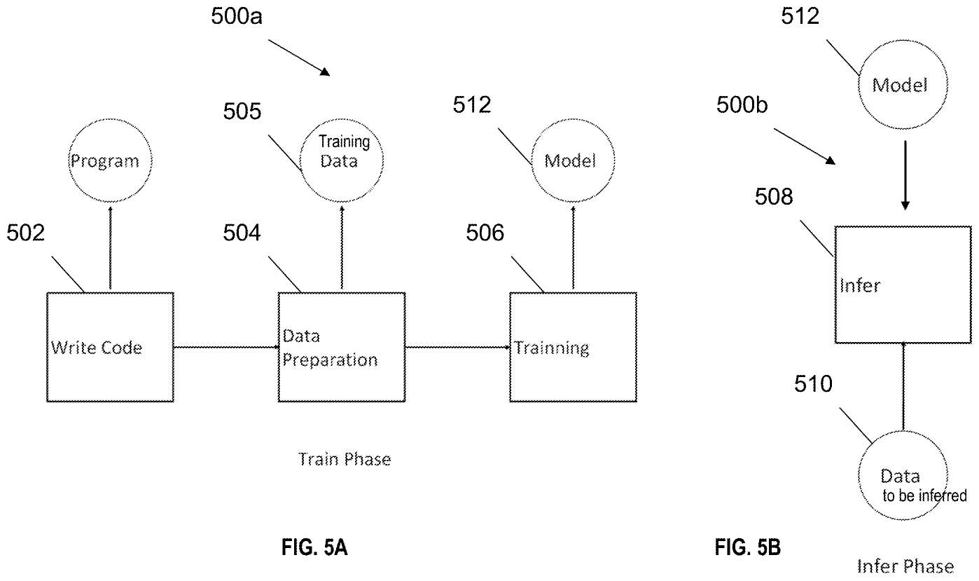

To accurately distinguish text styles in the document, the present disclosure provides the following methods. The first method is a style classifier that utilizes pattern recognition technology. In some implementations, the system can use a pattern recognition algorithm to classify the plurality of text blocks into the plurality of styles based on one or more features of each text block. The features can be visual features that are determined based on each text block (e.g., as described with further details with respect to FIG. 4). The second method is a style classifier based on a neural network machine learning model (e.g., as described with further details with respect to FIGS. 5A-5B). It should be appreciated that these methods are for illustration purposes and any other suitable classification methods may be applied to style classification on the document. In some implementations, the two style classifiers can be used in combination.

At 308, the system can determine a content type of each text block of the plurality of text blocks based on a style associated with the text block and textual information of the text block. The content type can be automatically determined by the system without user input or user interaction. In some implementations, the content type is selected from a plurality of pre-determined content types. Various AI algorithms, either alone or in combination, can be used to determine the content type of each text block. In some implementations, the AI algorithms for content type determination can be associated with inference rule sets and language models. The AI algorithms can make inferences to map a style to a content type based on various rules. For example, the font with the most characters is likely the “dish description” content type, the font with the least characters or the largest font may be the “dish category” content type, and the smallest font may be the “dish description” content type, etc. The language models, on the other hand, can be used by the AI algorithms to analyse textual information of a text block to determine a content type of the text block (e.g., whether a text block in a restaurant menu is a “dish name” or a “dish description”). For example, a large language model, such as Chat Generative Pre-trained Transformer (Chat GPT), can be employed in this context as a language model.

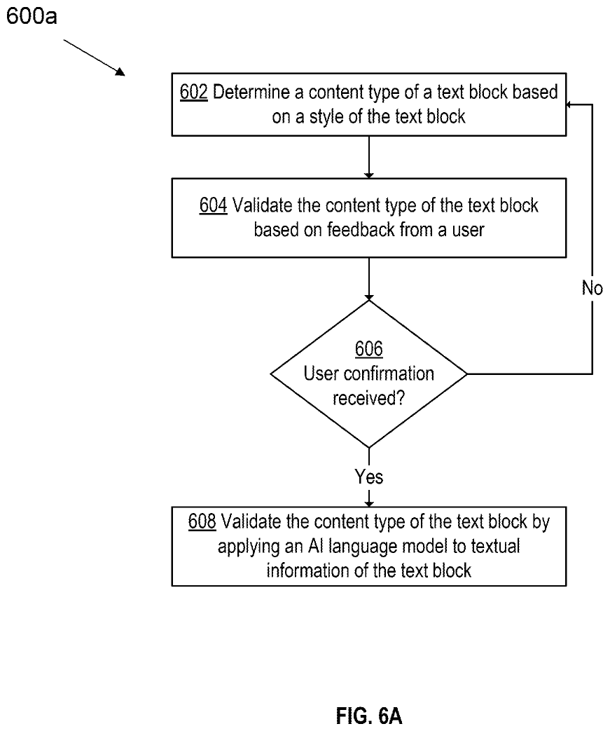

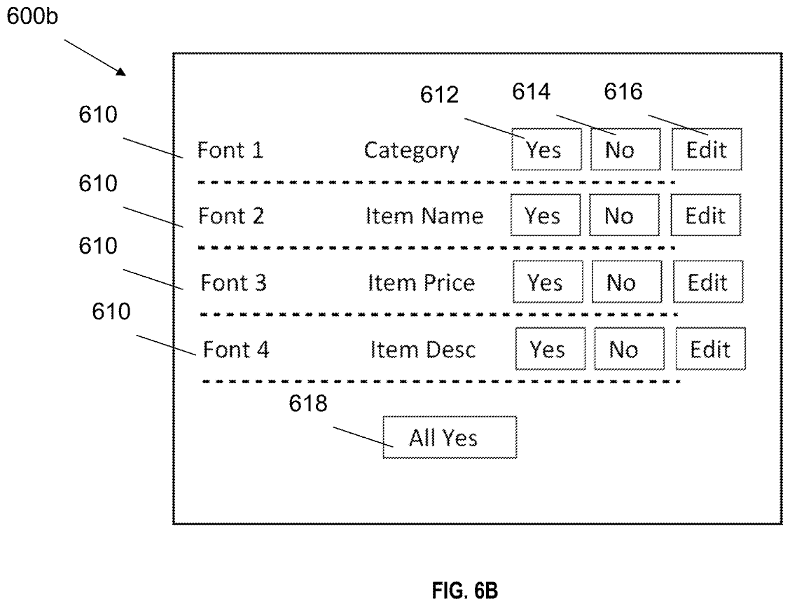

In some implementations, when determining the content type of each text block, the system can consider feedback from a user. Specifically, the user can confirm or validate results generated by the AI algorithms for content type determination. If there are any errors, the system may allow the user to delete the inferred results and may repeat 308 to generate new results, or the system may allow the user to modify the inferred result to correct the errors. Such operations may be repeated until the user confirms the results. Further details regarding 308 of method 300 will be provided in reference to FIGS. 6A-6B.

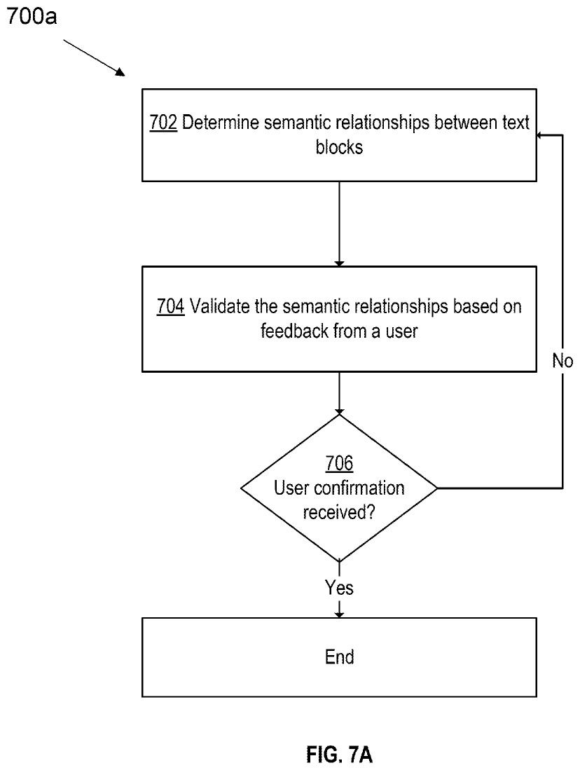

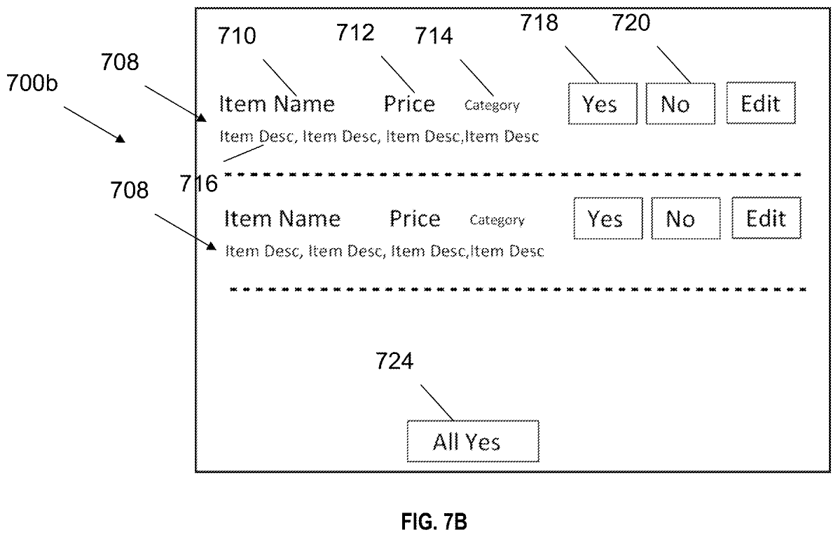

At 310, the system can determine semantic relationships between the plurality of text blocks. A semantic relationship between two text blocks can refer to the two text blocks being associated with each other. For example, a first text block whose content type is “dish price” (or “dish description”) may provide a price (or a description) of a second text block whose content type is “dish name.” In another example, a first text block whose content type is “dish name” may belong to a category represented by a second text block whose content type is “dish category.” In these situations, the system may determine that a semantic relationship between the first text block and the second text block exists. In other words, the first text block is associated with the second text block. The system can determine the semantic relationships between the plurality of text blocks based on factors including, but not limited to, a distance between two text blocks, relative locations of the plurality of text blocks, textual information of each text block, a content type of each text block, or any combination thereof. Further details regarding 310 of method 300 will be provided in reference to FIGS. 7A-7B.

At 312, the system can store the content type and the textual information of each text block and the semantic relationships between the plurality of text blocks into a database (e.g., database 108 of FIG. 1).

FIG. 4 illustrates some example visual features 401-406 used by a pattern recognition-based style classifier, in accordance with some aspects of the present disclosure. These visual features can be used, for example, at 306 of method 300 of FIG. 3.

Visual feature 401 is a font line width, which refers to a width of a stroke line of characters in a text block. The present disclosure provides an algorithm to calculate the width of the stroke lines. In some implementations, the algorithm can measure multiple stroke lines in the text block and take an average.

Visual feature 402 is a font color, which refers to a color of characters in the text block. Visual feature 402 can be obtained by using a program to retrieve the red, green, and blue (RGB) value of the font color.

Visual feature 403 is a font case, which is divided into two categories: all uppercase and mixed case. Even for the same font, all-uppercase and mixed-case fonts may represent different styles. So, these two situations can be classified and treated as two types of fonts. OCR recognition of the letters can provide information that helps identify the font case.

Visual feature 404 is a font line height (also called block height), which refers to the height of characters in the text block (e.g., a height of the highest character in the text block). In some implementations, after OCR recognition of the text block, the font line height of the text block is also given by the OCR recognition.

Visual feature 405 is a width of characters in the text block (e.g., average character width of the font). It may be difficult to calculate the width of each letter in the font. So, the average character width can be used as a feature. For example, the average character width can be obtained based on the width of the character block given by OCR divided by the number of letters (including spaces).

Visual feature 406 is character featured height. The featured height of a text block that includes a character string may be a group of numeric values, each value corresponding to a respective character in the character string. A height of a character can be classified into different categories depending on an upper limit and a lower limit the character occupies. For example, “acemnorsuvwxz” is a kind of height, “t” is another kind of height. Similarly, “bdfhikl,” “gpqy,” and “j” each belong to a different height type. In addition, uppercase letters belong to a separate height type. The so-called feature height is therefore recognized by these six different heights, forming an array that serves as the featured height of the font. In some implementations, an algorithm can be used to calculate the featured height of the font.

After obtaining the above six features, font classification may be carried out for the plurality of text blocks in the image. In some implementations, a decision tree algorithm may be used, which employs clustering algorithms at each level or layer of the decision tree to determine the number of branches for that level of the decision tree. After going through each layer of the decision tree, the font can be classified.

FIGS. 5A-5B illustrate an example process of a style classifier based on a neural network machine learning model, in accordance with some aspects of the present disclosure. This style classifier can be used, for example, at 306 of method 300 of FIG. 3. The process can be divided into a training phase 500a as shown in FIG. 5A and an inference phase 500b as shown in FIG. 5B. In the training phase 500a, training code is developed at 502, training data 505 is labelled at 504, and then training is executed at 506 to obtain a model 512. In the inference phase 500b, the model 512 (the trained model) can be deployed to an inference server 508. Data to be inferred 510 is sent to the inference server 508 that runs the model 512, and the model 512 can make inferences. In some implementations, this style classifier is a neural network based font classifier that processes font-related data.

In some implementations, the style classifier based on the neural network machine learning model can use a classic AlexNet structure with 5 convolutional layers and 3 fully connected layers. The present disclosure provides a data labelling method that can quickly generate the required training dataset.

In some implementations, the trained model is deployed to the inference server and carried out using the following workflow. 1. Text blocks recognized by the OCR model on a document are screened based on their positions and sizes. 2. The first text block is selected and marked as font 1 (2 for the second round). Then, the remaining text blocks are selected one by one and sent to the trained model in pairs with the first block. If they are not the same font as the first text block, they are not marked and are placed in the “unmarked” dataset. If they are the same font, they are marked as font 1 and removed from the “unmarked” dataset. 3. Step 2 is repeated until the number of text blocks in the “unmarked” dataset is zero.

FIG. 6A illustrates a flow chart of an example method 600a for a content type determination process, in accordance with some aspects of the present disclosure. Method 600a can be performed, for example, by system 100 of FIG. 1 at 308 of method 300 of FIG. 3.

At 602, the system can determine a content type of a text block based on a style of the text block. The style of the text block can be determined, for example, at 306 of method 300. In some implementations, the style can be a type of font. The system may perform semantic recognition on the style classification results to determine if a style relates to a content type (e.g., “dish category,” “dish name,” “dish price,” or “dish description” in the restaurant menu example described in reference to FIG. 2). The system may use various inference rules.

In some implementations, the system can sort the plurality of styles (which are determined, for example, at 306 of method 300) and arrange the plurality of styles in a hierarchical structure. The system may map each style to one of the plurality of pre-determined content types based on a rank of the style in the hierarchical structure.

For example, the pre-determined content types may include “dish category,” “dish name,” and “dish description” when the document is a restaurant menu. The plurality of styles can be sorted based on font size or character numbers and arranged in a hierarchical structure. The hierarchical structure can include three levels, with the first level being mapped to “dish category,” the second level being mapped to “dish name,” and the third level being mapped to “dish description.” As such, a style having the largest font size or the smallest number of characters can be ranked as the first level and mapped to the “dish category” content type. A style having a relatively large font size or a relatively large number of characters can be ranked as the second level and mapped to the “dish name” content type. A style having the smallest font size or the largest number of characters can be ranked as the third level and mapped to the “dish description” content type.

In some implementations, other inference rules can be used. For example, if a style having a relatively large font size and containing only numbers, then this style can be mapped to a “dish price” content type.

In some implementations, a combination of the aforementioned inference rules can be used. For example, if a font is the largest in all fonts, has multiple blocks of characters, and has fewer characters than other fonts, then this font is a “dish category.” If a font is larger in size in all fonts, has multiple character blocks, and has more characters than other fonts, then this font is a “dish name.” If a font is smaller in size in all fonts, has multiple character blocks, and has a particularly large number of characters, then this font is a “dish description.” If a font is larger in size in all fonts, has multiple character blocks, and contains only numbers, then this font is a “dish price.” In addition, AI language models can be used to judge whether the “dish category,” “dish name,” and “dish description” are semantically appropriate.

In some implementations, algorithms and processes can be designed to combine multiple inference rules to enhance the recognition accuracy. An example of such algorithms is described in the following steps.

At step one, the algorithm can classify the fonts on the menu using a trained neural network, obtain multiple fonts, and assign numbers to them, with each font containing multiple character blocks.

At step two, the algorithm can merge font classifications based on visual features such as “word block height,” “font color,” and “font width.” Thus, fonts that may have been classified into two categories can be combined by the neural network into one category.

At step three, based on some principles (for example, the font size for “dish category” should be larger than the font size for “dish name”; the font size for “dish name” should be larger than the font size for “dish description”; and “price” is a number), the algorithm can analyze the font classifications obtained in step two to arrange all possible combinations. The algorithm can form multiple solutions, with each solution suggesting which font type is suitable for “dish category,” “dish name,” and “dish description.”

At step four, the algorithm can feed the content of each word block in each font classification obtained in step two to a large language model like Chat GPT, allowing the large language model to determine whether the content belongs to “dish category,” “dish name,” “dish description,” or “price.” If it is determined that the majority of word blocks in a font belong to a particular category (e.g., “dish category”), then the algorithm can determine that the font belong to that category. The final result is that each font is assigned to a content type.

At step five, the algorithm can use the results from step four to check the results from step three. The algorithm can keep the ones that match to obtain one or more solutions.

At step six, the algorithm can check for each solution obtained in step five whether the distance between the category and item is close compared to other larger fonts. If not, this solution can be deleted. Also, the algorithm can check whether the distance between the description and item is close compared to other smaller fonts. If not, this solution can be deleted. In the end, one or more solutions can be obtained. If there are still multiple solutions, the multiple solutions can be presented to the user for them to choose.

At 604, the system can validate the content types determined at 602 based on feedback from a user. In some implementations, the system may present each style and a content type mapped to the style side by side to the user and receive the feedback from the user via a user interface, such as a user interface 600b as illustrated in FIG. 6B.

User interface 600b includes multiple lines 610. Each line 610 can include a style and a content type mapped to the style. Each line can further include clickable buttons 612, 614, and 616 that allow the user to provide feedback. In order to avoid user inconvenience, a navigation-based approach can be used where the user can click a button (e.g., button 612 or 618) to complete confirmation operations. For example, if the user accepts the mapping between a style and a content type in line 610, the user can click button 612. If the user detects a mapping error, the user may click button 614 to reject the mapping or may click button 616 to correct the mapping error by editing the style and the content type in line 610. User interface 600b can include button 618 to allow the user to accept multiple lines 610 with one click. In some implementations, each line 610 can present an example text block using the style in that line to provide more useful information to the user for making a judgement.

At 606, if the user confirms the content types determined at 602 and 604, method 600a proceeds to 608. Otherwise, if the user rejects a content type, method 600a returns to 602, where the system can re-determine the mapping between the plurality of content types and the plurality of styles based on feedback from the user. The system may repeat 602 and 604 several times until the content types determined at 602 are accepted by the user.

At 608, the system can further validate the content type of the text block by applying an AI language model to textual information of each text block. In other words, the AI language model can be used to check the textual information of each text block to determine whether the content type is semantically appropriate. For example, if textual information of a text block is “Salad,” then a content type of this text block should be “dish category,” not “dish price.” In some implementations, the AI language model used at 608 can catch an error that the user made or failed to detect at 604, thereby improving the recognition accuracy of the system.

It should be appreciated that the above examples are for illustration purposes and any other suitable rules or models may be applied to the content type determination process.

FIG. 7A illustrates a flow chart of an example method 700a for determining semantic relationships between text blocks, in accordance with some aspects of the present disclosure. Method 700a can be performed, for example, by system 100 of FIG. 1 at 310 of method 300.

At 702, the system can determine semantic relationships between text blocks based on one or more of the following rules. In some implementations, the system can determine that a first text block is associated with a second text block in response to determining that a content type of the first text block is associated with a content type of the second text block. For example, a text block of the “dish price” content type may be associated with another text block of the “dish name” content type. In some implementations, the system can determine that a first text block is associated with a second text block in response to determining that textual information of the first text block is associated with textual information of the second text block. For example, a text block “Caprese Salad” can be treated as an item in a category represented by another text block “Salad.” In some implementations, the system can determine that a first text block is associated with a second text block in response to determining that the first text block is within a threshold distance from the second text block or is closer to the second text block than other text blocks. For example, two adjacent text blocks may be associated with each other, and one text block may provide a price or a description to another text block. In some implementations, the distance between text blocks is given by OCR recognition.

At 704, the system can validate results determined at 702 based on feedback from a user. In some implementations, the system may present the results to the user and receive the feedback from the user via a navigation-based user interface, such as a user interface 700b as illustrated in FIG. 7B. As shown in FIG. 7B, text blocks that are associated with each other based on the semantic relationships between them can be placed in the same group and presented to the user. For example, group 708 includes text block 710 representing a name of a dish, text block 712 representing a price of the dish, text block 714 representing a category of the dish, and text block 716 representing a description of the dish. Similar to user interface 600b of FIG. 6B, the user can also accept, reject, or modify each group of the results by clicking respective buttons (e.g., buttons 718, 720, and 722) on user interface 700b. User interface 700b can include button 724 to allow the user to accept multiple groups with one click.

Returning to method 700a of FIG. 7A, at 706, if the user confirms the results determined at 702 and 704, method 700a will end. Otherwise, if the user rejects the results, method 700a returns to 702, where the system can re-determine the semantic relationships between text blocks based on the feedback from the user. The system may repeat 702 and 704 several times until the results are accepted by the user.

Embodiments of the subject matter and the operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

In this specification, the different functions can be implemented using “engines,” which broadly refer to software-based systems, subsystems, or processes that are programmed to perform one or more specific functions. Generally, an engine is implemented as one or more software modules or components, installed on one or more computers, in one or more locations. In some cases, one or more computers can be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing models described in this specification can also include, for example, special-purpose hardware accelerator units for processing common and compute-intensive parts of machine learning training or production, i.e., inference, workloads. Machine learning models can be implemented and deployed using a machine learning framework, e.g., a TensorFlow framework, a Microsoft Cognitive Toolkit framework, an Apache Singa framework, or an Apache MXNet framework.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any disclosure or on the scope of what may be claimed, but rather as descriptions of features that may be specific to particular embodiments of particular implementations. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claim in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described in this specification. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

1. A method performed by one or more computers, comprising:
obtaining an image of a document, wherein the image comprises a plurality of text blocks;
determining textual information of each text block of the plurality of text blocks using optical character recognition (OCR);
automatically classifying the plurality of text blocks into a plurality of styles;
automatically determining a content type of each text block of the plurality of text blocks based on a style associated with the text block and textual information of the text block, wherein the content type is selected from a plurality of pre-determined content types;
determining semantic relationships between the plurality of text blocks based on one or more of the content type, the textual information, or a location of each text block of the plurality of text blocks; and
storing the content type and the textual information of each text block and the semantic relationships between the plurality of text blocks into a database.

2. The method according to claim 1, wherein the plurality of text blocks are classified into the plurality of styles based on visual features of each text block comprising one or more of:
a width of a stroke line of characters in the text block;
a color of the characters in the text block;
whether the characters in the text block are uppercase letters;
a height of the characters in the text block; or
a width of the characters in the text block.

3. The method according to claim 2, wherein the visual features of each text block further comprise a sequence of numerical values, and wherein each of the sequence of numerical values is associated with a respective character in the text block and is determined based on an upper limit and a lower limit of a height of the respective character.

4. The method according to claim 1, wherein automatically classifying the plurality of text blocks into the plurality of styles comprises automatically classifying the plurality of text blocks using a neural network machine learning model.

5. The method according to claim 1, wherein automatically determining the content type of each text block comprises:
sorting the plurality of styles and arranging the plurality of styles in a hierarchical structure; and
mapping each style to one of the plurality of pre-determined content types based on a rank of the style in the hierarchical structure.

6. The method according to claim 5, wherein automatically determining the content type of each text block further comprises:
validating a mapping between the plurality of styles and the plurality of pre-determined content types based on feedback from a user.

7. The method according to claim 5, wherein automatically determining the content type of each text block further comprises:
determining the content type of each text block further based on semantic analysis of the textual information of the text block.

8. The method according to claim 1, wherein determining the semantic relationships between the plurality of text blocks comprises one or more of:
determining that a first text block of the plurality of text blocks is associated with a second text block of the plurality of text blocks in response to determining that a content type of the first text block is associated with a content type of the second text block;
determining that the first text block is associated with the second text block in response to determining that textual information of the first text block is associated with textual information of the second text block; or
determining that the first text block is associated with the second text block in response to determining that the first text block is within a threshold distance from the second text block or is closer to the second text block than other text blocks.

9. The method according to claim 8, wherein determining the semantic relationships between the plurality of text blocks further comprises:
validating the semantic relationships between the plurality of text blocks based on feedback from a user.

10. A system comprising:
one or more computers; and
one or more storage devices storing instructions that when executed by the one or more computers cause the one or more computers to perform operations comprising:
obtaining an image of a document, wherein the image comprises a plurality of text blocks;
determining textual information of each text block of the plurality of text blocks using optical character recognition (OCR);
automatically classifying the plurality of text blocks into a plurality of styles;
automatically determining a content type of each text block of the plurality of text blocks based on a style associated with the text block and textual information of the text block, wherein the content type is selected from a plurality of pre-determined content types;
determining semantic relationships between the plurality of text blocks based on one or more of the content type, the textual information, or a location of each text block of the plurality of text blocks; and
storing the content type and the textual information of each text block and the semantic relationships between the plurality of text blocks into a database.

11. The system according to claim 10, wherein the plurality of text blocks are classified into the plurality of styles based on visual features of each text block comprising one or more of:
a width of a stroke line of characters in the text block;
a color of the characters in the text block;
whether the characters in the text block are uppercase letters;
a height of the characters in the text block; or
a width of the characters in the text block.

12. The system according to claim 11, wherein the visual features of each text block further comprise a sequence of numerical values, and wherein each of the sequence of numerical values is associated with a respective character in the text block and is determined based on an upper limit and a lower limit of a height of the respective character.

13. The system according to claim 10, wherein classifying the plurality of text blocks into the plurality of styles comprises classifying the plurality of text blocks using a neural network machine learning model.

14. The system according to claim 10, wherein automatically determining the content type of each text block comprises:
sorting the plurality of styles and arranging the plurality of styles in a hierarchical structure; and
mapping each style to one of the plurality of pre-determined content types based on a rank of the style in the hierarchical structure.

15. The system according to claim 14, wherein automatically determining the content type of each text block further comprises:
validating a mapping between the plurality of styles and the plurality of pre-determined content types based on feedback from a user.

16. The system according to claim 14, wherein automatically determining the content type of each text block further comprises:
determining the content type of each text block further based on semantic analysis of the textual information of the text block.

17. The system according to claim 10, wherein determining the semantic relationships between the plurality of text blocks comprises one or more of:
determining that a first text block of the plurality of text blocks is associated with a second text block of the plurality of text blocks in response to determining that a content type of the first text block is associated with a content type of the second text block;
determining that the first text block is associated with the second text block in response to determining that textual information of the first text block is associated with textual information of the second text block; or
determining that the first text block is associated with the second text block in response to determining that the first text block is within a threshold distance from the second text block or is closer to the second text block than other text blocks.

18. The system according to claim 17, wherein determining the semantic relationships between the plurality of text blocks further comprises:
validating the semantic relationships between the plurality of text blocks based on feedback from a user.

19. A non-transitory computer-readable storage medium storing instructions that when executed by one or more computers cause the one or more computers to perform operations comprising:
obtaining an image of a document, wherein the image comprises a plurality of text blocks;
determining textual information of each text block of the plurality of text blocks using optical character recognition (OCR);
automatically classifying the plurality of text blocks into a plurality of styles;
automatically determining a content type of each text block of the plurality of text blocks based on a style associated with the text block and textual information of the text block, wherein the content type is selected from a plurality of pre-determined content types;
determining semantic relationships between the plurality of text blocks based on one or more of the content type, the textual information, or a location of each text block of the plurality of text blocks; and
storing the content type and the textual information of each text block and the semantic relationships between the plurality of text blocks into a database.

20. The non-transitory computer-readable storage medium according to claim 19, wherein the plurality of text blocks are classified into the plurality of styles based on visual features of each text block comprising one or more of:
a width of a stroke line of characters in the text block;
a color of the characters in the text block;
whether the characters in the text block are uppercase letters;
a height of the characters in the text block; or
a width of the characters in the text block.
